(19) United States
(12) Patent Application Publication
(10) Pub. No.: US 2026/0116036 A1
(43) Pub. Date: Apr. 30, 2026

(54) MICRO-PERFORATED SANDWICH SOUND-ABSORBING AND LOAD-BEARING STRUCTURE FILLED WITH POLYURETHANE AND PREPARATION METHOD THEREOF

(71) Applicant: North University of China, Taiyuan City (CN)

(72) Inventors: Zhonghua LI, Taiyuan City (CN); Bin LIU, Taiyuan City (CN); Pengfei ZHANG, Taiyuan City (CN); Peikang BAI, Taiyuan City (CN); Qifei ZHANG, Taiyuan City (CN); Yujun ZHOU, Taiyuan City (CN); Ruixing HAO, Taiyuan City (CN); Sichen PEI, Taiyuan City (CN); Lipeng GE, Taiyuan City (CN)

(21) Appl. No.: 19/003,395

(22) Filed: Dec. 27, 2024

(30) Foreign Application Priority Data
Jan. 5, 2024 (CN) 202410018689.4

(51) Int. Cl. B32B 3/26; B32B 3/12; B32B 15/01; B32B 38/00; B32B 38/08

(52) U.S. Cl. CPC B32B 3/266; B32B 3/12; B32B 15/01; B32B 38/0036; B32B 38/08; B32B 2250/03; B32B 2260/046; B32B 2266/045; B32B 2266/10; B32B 2307/102; B32B 2307/7376; B32B 2310/0843

(57) ABSTRACT

A micro-perforated sandwich sound-absorbing and load-bearing structure filled with polyurethane and a preparation method thereof are particularly provided. The micro-perforated sandwich sound-absorbing and load-bearing structure filled with polyurethane includes a sandwich layer, a solid panel, a micro-perforated panel and a polyurethane filling layer. The sandwich layer, the solid panel and the micro-perforated panel are all made of titanium alloy. The sandwich layer is of a triply periodic minimal surface porous structure. An upper surface of the solid panel is integrally connected with a lower surface of the sandwich layer. Multiple micro-pores are formed in a surface of the micro-perforated panel in a running-through manner, and a lower surface of the micro-perforated panel is integrally connected with an upper surface of the sandwich layer. The polyurethane filling layer uniformly fills in the sandwich layer.

### CROSS-REFERENCE TO RELATED APPLICATION

This patent application claims the benefit and priority of Chinese Patent Application No. 202410018689.4 filed with the China National Intellectual Property Administration on Jan. 5, 2024, the disclosure of which is incorporated by reference herein in its entirety as part of the present application.

### TECHNICAL FIELD

The present disclosure relates to the technical field of sound-absorbing and load-bearing structures, and in particular to a micro-perforated sandwich sound-absorbing and load-bearing structure filled with polyurethane and a preparation method thereof.

### BACKGROUND

A sound-absorbing and load-bearing structure is a structure with both sound-absorbing and load-bearing functions, which is widely used in aircraft, spacecraft, submarines, armored vehicles and other major equipment. However, in practice, an existing sound-absorbing and load-bearing structure, due to limitations of its own structure, generally has the problems of a weak sound absorption effect, a narrow sound absorption band, low overall specific strength and specific stiffness and a heavy entire mass, resulting in poor sound-absorbing and load-bearing properties. Based on this, it is necessary to propose a micro-perforated sandwich sound-absorbing and load-bearing structure filled with polyurethane and a preparation method thereof to solve the above-mentioned problems of the existing sound-absorbing and load-bearing structure.

### SUMMARY

In order to solve the problem of poor sound-absorbing and load-bearing properties of an existing sound-absorbing and load-bearing structure, the present disclosure provides a micro-perforated sandwich sound-absorbing and load-bearing structure filled with polyurethane and a preparation method thereof.

The present disclosure is implemented by using the following technical solutions.

A micro-perforated sandwich sound-absorbing and load-bearing structure filled with polyurethane includes a sandwich layer, a solid panel, a micro-perforated panel and a polyurethane filling layer. The sandwich layer, the solid panel and the micro-perforated panel are all made of titanium alloy; the sandwich layer is of a triply periodic minimal surface porous structure; an upper surface of the solid panel is integrally connected with a lower surface of the sandwich layer; multiple micro-pores are formed in a surface of the micro-perforated panel in a running-through manner, and a lower surface of the micro-perforated panel is integrally connected with an upper surface of the sandwich layer; the polyurethane filling layer uniformly fills in the sandwich layer, and an upper surface of the polyurethane filling layer is connected to the lower surface of the micro-perforated panel.

The titanium alloy is Ti6Al4V; each of unit cells of the triply periodic minimal surface porous structure is in a shape of a Diamond structure; sizes of each of the unit cells of the triply periodic minimal surface porous structure in x, y and z directions are 5 mm, 5 mm and 5 mm respectively; numbers of the unit cells of the triply periodic minimal surface porous structure in the x, y and z directions are 20, 20 and 3 respectively; a volume fraction of each of the unit cells of the triply periodic minimal surface porous structure is 20%; a length, a width and a thickness of the sandwich layer are 100 mm, 100 mm and 15 mm respectively; a length, a width and a thickness of the solid panel are 100 mm, 100 mm and 1.5 mm respectively; a length, a width and a thickness of the micro-perforated panel are 100 mm, 100 mm and 1.5 mm respectively; and a diameter of each of the multiple micro-pores is less than or equal to 1 mm.

An implicit function expression of a unicellular surface of the triply periodic minimal surface porous structure is as follows:

$${φ}_{D} ( x , y , z ) = sin ( ax ) * sin ( β y ) * sin ( γ z ) + sin ( a x ) * cos ( β y ) * cos ( γ z ) + cos ( a x ) * sin ( βy ) * cos ( γ z ) + cos ( a x ) * cos ( β y ) * sin ( γ z ) + {R}_{D} = 0 ,$$

where: R_{D} is a morphology control parameter that is configured to adjust a porosity of the triply periodic minimal surface porous structure; R_{D}=0.72285; α, β and γ are size control parameters of the unit cells, which determine sizes of the unit cells of the triply periodic minimal surface porous structure in x, y and z directions; α=β=γ=1.

A method for preparing a micro-perforated sandwich sound-absorbing and load-bearing structure filled with polyurethane (the method is used for preparing the micro-perforated sandwich sound-absorbing and load-bearing structure filled with polyurethane according to the present disclosure) is provided. The method is implemented by the following steps:
S1: setting a shape, a size and a volume fraction of each of unit cells and a number of the unit cells of the triply periodic minimal surface porous structure by using a three-dimensional modeling software; building, according to an implicit function expression of a unicellular surface of the triply periodic minimal surface porous structure, a unicellular surface model of the triply periodic minimal surface porous structure by using the three-dimensional modeling software; performing a repair operation on the unicellular surface model by using the three-dimensional modeling software to obtain a complete unicellular model; and performing an array operation on the complete unicellular model by using the three-dimensional modeling software to obtain a solid model of the sandwich layer;
S2: building a solid model of the solid panel on a lower surface of the solid model of the sandwich layer by using the three-dimensional modeling software, and building a solid model of the micro-perforated panel on an upper surface of the solid model of the sandwich layer; slicing the solid model of the sandwich layer by using the three-dimensional modeling software, with a thickness of a slice being 0.03 mm; optimizing quality of a triangular patch at a joint interface between the solid model of the solid panel and the solid model of the sandwich layer, and quality of a triangular patch at a joint interface between the solid model of the micro-perforated panel and the solid model of the sandwich layer by using the three-dimensional modeling software;
S3: performing integrated machining by using a selective laser melting apparatus according to the solid model of the sandwich layer, the solid model of the solid panel and the solid model of the micro-perforated panel, with titanium alloy powder as a raw material, to obtain the sandwich layer, the solid panel and the micro-perforated panel, which together form the micro-perforated sandwich sound-absorbing and load-bearing structure; and
S4: adding cellulose to an aqueous polyurethane solution and stirring for 24 hours by a magnetic stirrer to obtain a mixed solution; downwardly placing the micro-perforated panel of the micro-perforated sandwich sound-absorbing and load-bearing structure in a mold, and pouring the mixed solution into the mold to cause the sandwich layer of the micro-perforated sandwich sound-absorbing and load-bearing structure to be immersed in the mixed solution; performing oriented freezing on the mixed solution, and then placing the mixed solution in a refrigeration dryer for cold drying to cure the mixed solution into the polyurethane filling layer; and constituting the micro-perforated sandwich sound-absorbing and load-bearing structure filled with polyurethane, by the sandwich layer, the solid panel, the micro-perforated panel and the polyurethane filling layer.

In S1, the repair operation includes offsetting, thickening and Boolean operation.

In S4, an amount of the cellulose is 1% of a sum of solid contents of the cellulose and the polyurethane; and a mass fraction of the aqueous polyurethane solution is 10%.

Compared with the existing sound-absorbing and load-bearing structure, the micro-perforated sandwich sound-absorbing and load-bearing structure filled with polyurethane according to the present disclosure has the following advantages.

First, in the present disclosure, the micro-pores in the micro-perforated panel and the triply periodic minimal surface porous structure of the sandwich layer together constitute a resonant sound-absorbing structure, which can be regarded as a parallel combination of multiple Helmholtz resonators and can therefore also be regarded as a resonant system consisting of a mass and a spring. When the frequency of incident sound waves is consistent with the resonant frequency of the system, air at necks of the micro-pores produce intense vibration and friction, forming a process of transforming sound energy into thermal energy. Therefore, the sound-absorbing effect is enhanced, and an absorption peak is formed, which significantly attenuates the sound energy, thereby significantly enhancing the sound-absorbing property. In addition, according to the present disclosure, the sound resistance of the resonant sound-absorbing structure is increased by providing the polyurethane filling layer, such that the sound absorption band is broadened, thereby further enhancing the sound-absorbing property (as shown in FIG. 5, the peak value of the sound absorption coefficient of the micro-perforated sandwich sound-absorbing and load-bearing structure filled with polyurethane is shifted to the low frequency as compared to a micro-perforated sandwich sound-absorbing and load-bearing structure not filled with polyurethane, indicating that the sound absorption band is broadened).

Second, in the present disclosure, the sandwich layer is of the triply periodic minimal surface porous structure with ultra-high specific strength and specific stiffness, self-supporting property and uniform stress distribution, and the sandwich layer, the solid panel and the micro-perforated panel are all made of titanium alloy with ultra-light mass. Therefore, the entire specific strength and specific stiffness are significantly improved, and the entire mass is significantly reduced, thereby significantly enhancing the load-bearing property.

The present disclosure solves the problem that the existing sound-absorbing and load-bearing structure has poor sound-absorbing and load-bearing properties, and is suitable for aircraft, spacecraft, submarines, armored vehicles and other major equipment.

### BRIEF DESCRIPTION OF THE DRAWINGS

FIG. 1 is a schematic structural diagram according to the present disclosure;

FIG. 2 is an exploded structural diagram of FIG. 1;

FIG. 3 is a schematic structural diagram of a micro-perforated panel according to the present disclosure;

FIG. 4 is a schematic diagram of S1 according to the present disclosure;

FIG. 5 is a graph of sound absorption coefficients of a micro-perforated sandwich sound-absorbing and load-bearing structure not filled with polyurethane and a micro-perforated sandwich sound-absorbing and load-bearing structure filled with polyurethane; and

FIG. 6 is a flowchart of a method for preparing a micro-perforated sandwich sound-absorbing and load-bearing structure filled with polyurethane.

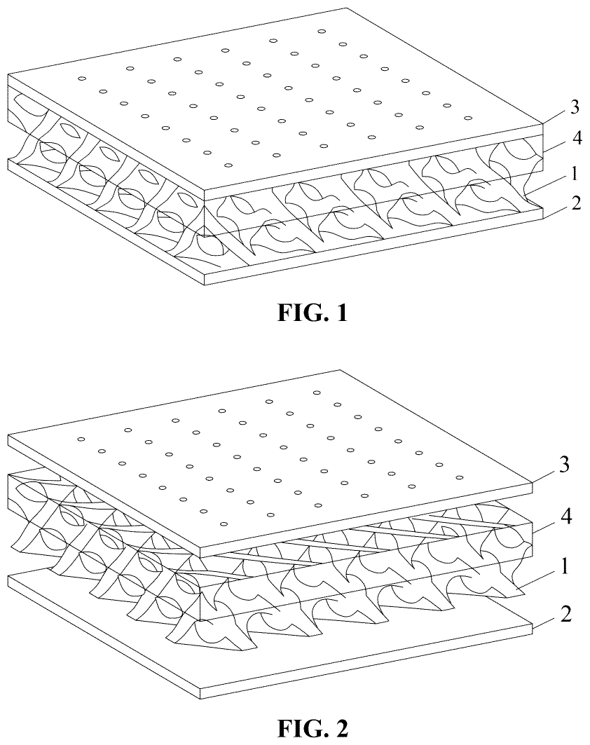

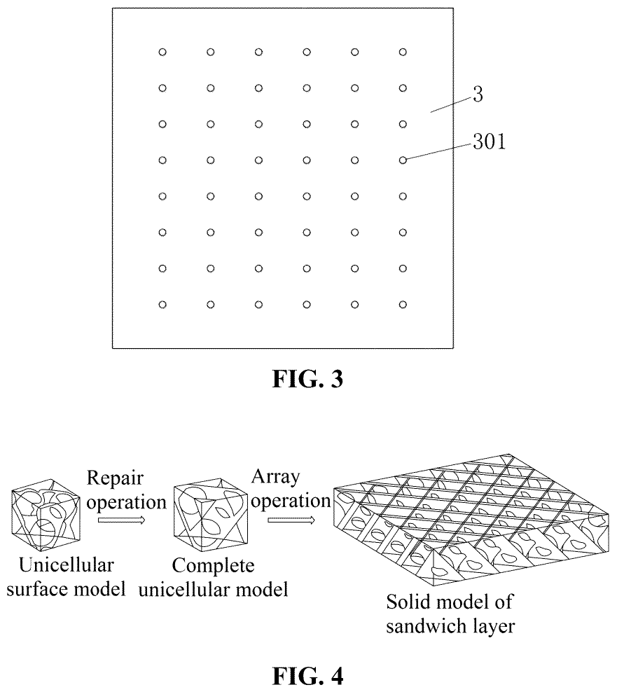

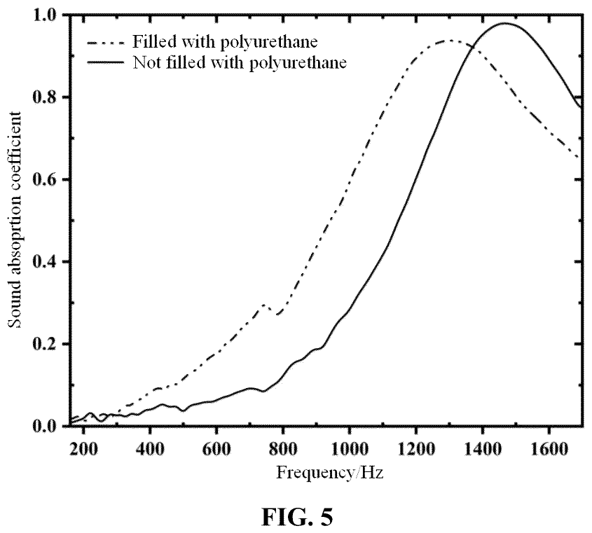

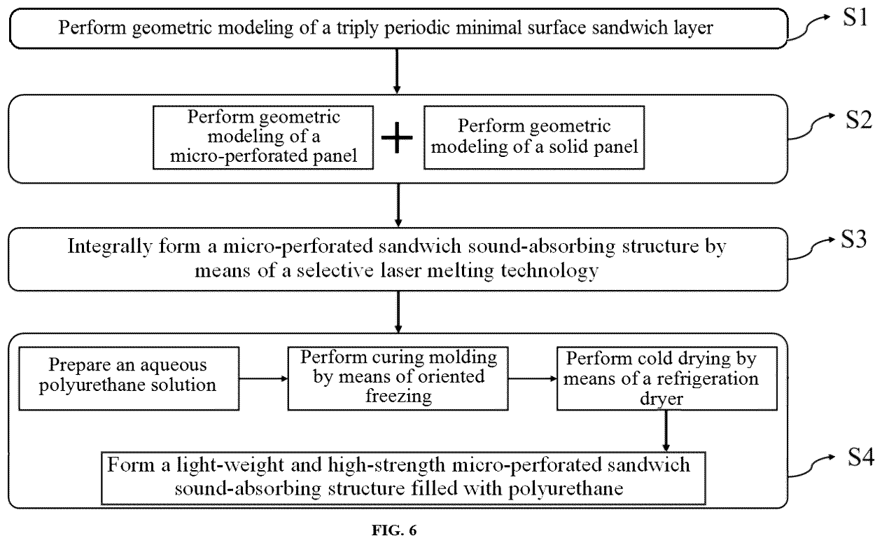

In the figures: 1 sandwich layer, 2 solid panel, 3 micro-perforated panel, 301 micro-pore, 4 polyurethane filling layer.

### DETAILED DESCRIPTION OF THE EMBODIMENTS

A micro-perforated sandwich sound-absorbing and load-bearing structure filled with polyurethane includes a sandwich layer 1, a solid panel 2, a micro-perforated panel 3 and a polyurethane filling layer. The sandwich layer 1, the solid panel 2 and the micro-perforated panel 3 are all made of titanium alloy. The sandwich layer 1 is of a triply periodic minimal surface porous structure; an upper surface of the solid panel 2 is integrally connected with a lower surface of the sandwich layer 1. Multiple micro-pores 301 are formed in a surface of the micro-perforated panel 3 in a running-through manner, and a lower surface of the micro-perforated panel 3 is integrally connected with an upper surface of the sandwich layer 1. The polyurethane filling layer 4 uniformly fills in the sandwich layer 1, and an upper surface of the polyurethane filling layer 4 is connected to the lower surface of the micro-perforated panel.

The titanium alloy is Ti6Al4V. Each of unit cells of the triply periodic minimal surface porous structure is in a shape of a Diamond structure; sizes of each of the unit cells of the triply periodic minimal surface porous structure in x, y and z directions are 5 mm, 5 mm and 5 mm respectively. Numbers of the unit cells of the triply periodic minimal surface porous structure in the x, y and z directions are 20, 20 and 3 respectively. A volume fraction of each of the unit cells of the triply periodic minimal surface porous structure is 20%. A length, a width and a thickness of the sandwich layer 1 are 100 mm, 100 mm and 15 mm respectively. A length, a width and a thickness of the solid panel 2 are 100 mm, 100 mm and 1.5 mm respectively. A length, a width and a thickness of the micro-perforated panel 3 are 100 mm, 100 mm and 1.5 mm respectively. A diameter of each of the multiple micro-pores 301 is less than or equal to 1 mm.

An implicit function expression of a unicellular surface of the triply periodic minimal surface porous structure is as follows:

$${φ}_{D} ( x , y , z ) = sin ( ax ) * sin ( β y ) * sin ( γ z ) + sin ( a x ) * cos ( β y ) * cos ( γ z ) + cos ( a x ) * sin ( βy ) * cos ( γ z ) + cos ( a x ) * cos ( β y ) * sin ( γ z ) + {R}_{D} = 0 ,$$

where: R_{D} is a morphology control parameter that is configured to adjust a porosity of the triply periodic minimal surface porous structure; R_{D}=0.72285; α, β and γ are size control parameters of the unit cells, which determine sizes of the unit cells of the triply periodic minimal surface porous structure in x, y and z directions; α=β=γ=1.

A method for preparing a micro-perforated sandwich sound-absorbing and load-bearing structure filled with polyurethane (the method is used for preparing the micro-perforated sandwich sound-absorbing and load-bearing structure filled with polyurethane according to the present disclosure) is provided. The method is implemented by the following steps.
S1: a shape, a size and a volume fraction of each of unit cells and a number of the unit cells of the triply periodic minimal surface porous structure are set by using a three-dimensional modeling software; according to an implicit function expression of a unicellular surface of the triply periodic minimal surface porous structure, a unicellular surface model of the triply periodic minimal surface porous structure is built by using the three-dimensional modeling software; a repair operation is performed on the unicellular surface model by using the three-dimensional modeling software to obtain a complete unicellular model; and an array operation is performed on the complete unicellular model by using the three-dimensional modeling software to obtain a solid model of the sandwich layer 1.
S2: a solid model of a solid panel 2 is built on a lower surface of the solid model of the sandwich layer 1 by using the three-dimensional modeling software, and a solid model of the micro-perforated panel 3 is built on an upper surface of the solid model of the sandwich layer 1; the solid model of the sandwich layer 1 is sliced by using the three-dimensional modeling software, with a thickness of a slice being 0.03 mm; quality of a triangular patch at a joint interface between the solid model of the solid panel 2 and the solid model of the sandwich layer 1, and quality of a triangular patch at a joint interface between the solid model of the micro-perforated panel 3 and the solid model of the sandwich layer 1 are optimized by using the three-dimensional modeling software.
S3: integrated machining is performed by using a selective laser melting apparatus according to the solid model of the sandwich layer 1, the solid model of the solid panel 2 and the solid model of the micro-perforated panel 3, with titanium alloy powder as a raw material, to obtain the sandwich layer 1, the solid panel 2 and the micro-perforated panel 3, which together form the micro-perforated sandwich sound-absorbing and load-bearing structure.
S4: cellulose is added to an aqueous polyurethane solution and stirred for 24 hours by a magnetic stirrer to obtain a mixed solution; the micro-perforated panel 3 of the micro-perforated sandwich sound-absorbing and load-bearing structure is placed downwardly in a mold, and the mixed solution is poured into the mold to cause the sandwich layer 1 of the micro-perforated sandwich sound-absorbing and load-bearing structure to be immersed in the mixed solution; oriented freezing is performed on the mixed solution, and then the mixed solution is placed in a refrigeration dryer for cold drying to cure the mixed solution into the polyurethane filling layer 4; the micro-perforated sandwich sound-absorbing and load-bearing structure filled with polyurethane are formed by the sandwich layer 1, the solid panel 2, the micro-perforated panel 3 and the polyurethane filling layer 4.

In S1, the repair operation includes offsetting, thickening and Boolean operation.

In S4, an amount of the cellulose is 1% of a sum of solid contents of the cellulose and the polyurethane; and a mass fraction of the aqueous polyurethane solution is 10%.

Although specific implementations of the present disclosure have been described above, those skilled in the art should understand that these are only illustrative, and the scope of protection of the present disclosure is defined by the appended claims. Various alterations or modifications to these implementations can be made by those skilled in the art without departing from the principle and essence of the present disclosure. However, these alterations and modifications all fall within the scope of protection of the present disclosure.

What is claimed is:

1. A micro-perforated sandwich sound-absorbing and load-bearing structure filled with polyurethane, comprising a sandwich layer (1), a solid panel (2), a micro-perforated panel (3) and a polyurethane filling layer (4); wherein the sandwich layer (1), the solid panel (2) and the micro-perforated panel (3) are all made of titanium alloy; the sandwich layer (1) is of a triply periodic minimal surface porous structure; an upper surface of the solid panel (2) is integrally connected with a lower surface of the sandwich layer (1); a plurality of micro-pores (301) are formed in a surface of the micro-perforated panel (3) in a running-through manner, and a lower surface of the micro-perforated panel (3) is integrally connected with an upper surface of the sandwich layer (1); the polyurethane filling layer (4) uniformly fills in the sandwich layer (1), and an upper surface of the polyurethane filling layer (4) is connected to the lower surface of the micro-perforated panel (3).

2. The micro-perforated sandwich sound-absorbing and load-bearing structure filled with polyurethane according to claim 1, wherein the titanium alloy is Ti6Al4V; each of unit cells of the triply periodic minimal surface porous structure is in a shape of a Diamond structure; sizes of each of the unit cells of the triply periodic minimal surface porous structure in x, y and z directions are 5 mm, 5 mm and 5 mm respectively; numbers of the unit cells of the triply periodic minimal surface porous structure in the x, y and z directions are 20, 20 and 3 respectively; a volume fraction of each of the unit cells of the triply periodic minimal surface porous structure is 20%; a length, a width and a thickness of the sandwich layer (1) are 100 mm, 100 mm and 15 mm respectively; a length, a width and a thickness of the solid panel (2) are 100 mm, 100 mm and 1.5 mm respectively; a length, a width and a thickness of the micro-perforated panel (3) are 100 mm, 100 mm and 1.5 mm respectively; and a diameter of each of the plurality of micro-pores (301) is less than or equal to 1 mm.

3. The micro-perforated sandwich sound-absorbing and load-bearing structure filled with polyurethane according to claim 1, wherein an implicit function expression of a unicellular surface of the triply periodic minimal surface porous structure is as follows:
$${φ}_{D} ( x , y , z ) = sin ( ax ) * sin ( β y ) * sin ( γ z ) + sin ( a x ) * cos ( β y ) * cos ( γ z ) + cos ( a x ) * sin ( βy ) * cos ( γ z ) + cos ( a x ) * cos ( β y ) * sin ( γ z ) + {R}_{D} = 0 ,$$
wherein: R_{D} is a morphology control parameter that is configured to adjust a porosity of the triply periodic minimal surface porous structure; R_{D}=0.72285; α, β and γ are size control parameters of the unit cells, which determine sizes of the unit cells of the triply periodic minimal surface porous structure in x, y and z directions; α=β=γ=1.

4. A method for preparing a micro-perforated sandwich sound-absorbing and load-bearing structure filled with polyurethane, being used for preparing the micro-perforated sandwich sound-absorbing and load-bearing structure filled with polyurethane according to claim 1, wherein the method is implemented by the following steps:
S1: setting a shape, a size and a volume fraction of each of unit cells and a number of the unit cells of the triply periodic minimal surface porous structure by using a three-dimensional modeling software; building, according to an implicit function expression of a unicellular surface of the triply periodic minimal surface porous structure, a unicellular surface model of the triply periodic minimal surface porous structure by using the three-dimensional modeling software; performing a repair operation on the unicellular surface model by using the three-dimensional modeling software to obtain a complete unicellular model; and performing an array operation on the complete unicellular model by using the three-dimensional modeling software to obtain a solid model of the sandwich layer (1);
S2: building a solid model of the solid panel (2) on a lower surface of the solid model of the sandwich layer (1) by using the three-dimensional modeling software, and building a solid model of the micro-perforated panel (3) on an upper surface of the solid model of the sandwich layer (1); slicing the solid model of the sandwich layer (1) by using the three-dimensional modeling software, with a thickness of a slice being 0.03 mm; optimizing quality of a triangular patch at a joint interface between the solid model of the solid panel (2) and the solid model of the sandwich layer (1), and quality of a triangular patch at a joint interface between the solid model of the micro-perforated panel (3) and the solid model of the sandwich layer (1) by using the three-dimensional modeling software;
S3: performing integrated machining by using a selective laser melting apparatus according to the solid model of the sandwich layer (1), the solid model of the solid panel (2) and the solid model of the micro-perforated panel (3), with titanium alloy powder as a raw material, to obtain the sandwich layer (1), the solid panel (2) and the micro-perforated panel (3), which together form the micro-perforated sandwich sound-absorbing and load-bearing structure; and
S4: adding cellulose to an aqueous polyurethane solution and stirring for 24 hours by a magnetic stirrer to obtain a mixed solution; downwardly placing the micro-perforated panel (3) of the micro-perforated sandwich sound-absorbing and load-bearing structure in a mold, and pouring the mixed solution into the mold to cause the sandwich layer (1) of the micro-perforated sandwich sound-absorbing and load-bearing structure to be immersed in the mixed solution; performing oriented freezing on the mixed solution, and then placing the mixed solution in a refrigeration dryer for cold drying to cure the mixed solution into the polyurethane filling layer (4); and constituting the micro-perforated sandwich sound-absorbing and load-bearing structure filled with polyurethane, by the sandwich layer (1), the solid panel (2), the micro-perforated panel (3) and the polyurethane filling layer (4).

5. The method for preparing a micro-perforated sandwich sound-absorbing and load-bearing structure filled with polyurethane according to claim 4, wherein in S1, the repair operation comprises offsetting, thickening and Boolean operation.

6. The method for preparing a micro-perforated sandwich sound-absorbing and load-bearing structure filled with polyurethane according to claim 4, wherein in S4, an amount of the cellulose is 1% of a sum of solid contents of the cellulose and the polyurethane; and a mass fraction of the aqueous polyurethane solution is 10%.
